(19) United States
(12) Patent Application Publication
(10) Pub. No.: US 2023/0395825 A1
(43) Pub. Date: Dec. 7, 2023

(54) BIPOLAR PLATE FOR AN ELECTROCHEMICAL SYSTEM, AND ASSEMBLY OF SUCH BIPOLAR PLATES

(71) Applicant: Reinz-Dichtungs-GmbH, Neu-Ulm (DE)

(72) Inventors: André SPEIDEL, Bussmanshausen (DE); Rainer GLUECK, Tomerdingen (DE); Felix SENF, Ulm (DE)

(21) Appl. No.: 18/328,573

(22) Filed: Jun. 2, 2023

(30) Foreign Application Priority Data
Jun. 2, 2022 (DE) 20 2022 103 147.9

(51) Int. Cl. H01M 8/026; H01M 8/0284; H01M 8/0276

(52) U.S. Cl. CPC H01M 8/026; H01M 8/0284; H01M 8/0276

(57) ABSTRACT

A bipolar plate for an electrochemical system, comprising a first separator plate and a second separator plate. The first and the second separator plate each comprising: at least two through-openings, an active region, and a distribution or collection region with structures for guiding a reaction medium between one of the through-openings and the active region. The structures for guiding the reaction medium in the distribution or collection region comprise flow channels for the respective reaction medium, said flow channels being separated from each other by webs. Adjacent to the first through-opening, the separator plates bear directly against each other in a contact plane. The distribution or collection region of the first separator plate and/or the distribution or collection region of the second separator plate have at least one compensating region.

### CROSS-REFERENCE TO RELATED APPLICATION

The present application claims priority to German Utility Model Application No. 20 2022 103 147.9, entitled “BIPOLAR PLATE FOR AN ELECTROCHEMICAL SYSTEM, AND ASSEMBLY OF SUCH BIPOLAR PLATES”, and filed on Jun. 2, 2022. The entire contents of the above-listed application is hereby incorporated by reference for all purposes.

### TECHNICAL FIELD

The present disclosure relates to a bipolar plate for an electrochemical system, and to an assembly of such bipolar plates. Such bipolar plates are used in electrochemical systems, for example in electrolyzers, fuel cells, electrochemical compressors, or redox flow batteries. For this, bipolar plates and membrane electrode assemblies (MEAs) are usually arranged in an alternating fashion with additional components at the respective ends, so as to form a stack of an electrochemical system, and are compressed.

### BACKGROUND AND SUMMARY

In one type of construction, such bipolar plates comprise at least two separator plates, which are arranged adjacent to each other in a direction perpendicular to the plate plane of the first and/or the second separator plate. These two separator plates are usually joined to each other, for example by welding. If cooling is required, it is possible to pass a coolant between the separator plates. However, such cooling is often not required, such as in the case of electrolyzers.

Each of the separator plates, and thus also the bipolar plate, has an active region which comprises structures, such as embossed channels, for guiding a reaction medium along the outer side of the bipolar plate. These structures are usually designed as flow channels, through which gaseous or also liquid reaction media and reaction products can be passed. These reaction media are supplied to the active region from a through-opening in the respective separator plate via a distribution region. Remaining reaction medium and reaction products are correspondingly discharged via a collection region and a through-opening in the respective separator plate. The distribution regions and/or collection regions also usually have, as fluid-guiding structures, flow channels designed as grooves which are separated from each other by webs. The rear sides of the grooves and webs of the two separator plates span the flow area for coolant in the interior of the bipolar plate.

Adjacent to the through-opening, the two separator plates are arranged bearing directly against each other in a contact plane and are joined to each other in places, such as by welding, for example by welding in a media-tight manner, in order to mechanically support the two separator plates and to seal between the two separator plates. Furthermore, in conventional bipolar plates, the two separator plates are often also joined to each other in the distribution and/or collection region, for example by means of welded joints which, on account of the coolant being guided between the two separator plates, extend only over short sections in order to only minimally impede the coolant flow.

When forming a ready-to-use stack, a membrane electrode assembly is provided between adjacent bipolar plates, which membrane electrode assembly, in the flow region, separates the channels for the passage of the reaction medium in a first bipolar plate from the channels for the passage of another reaction medium in a second bipolar plate, said second bipolar plate being separated from the first bipolar plate only by the membrane electrode assembly. The membrane electrode assembly, typically abbreviated as MEA, extends beyond the active region into the distribution region and possibly the collection region.

In its active region, the MEA usually comprises the actual proton-conducting membrane and the electrodes and catalyst layers applied thereto, to which conductive and gas-permeable layers, so-called gas diffusion layers (GDLs), are applied. In its edge region, the MEA usually comprises a polymer-based film material, which surrounds the active region and in a narrow overlap region overlaps with the materials forming the active region, or with some of these materials, e.g. possibly not with the GDLs. In a stack of an electrochemical system, the MEA defines the spacing between the separator plates. At the same time, gas diffusion layers (GDLs) exhibit relatively large fluctuations in terms of their thickness.

Therefore, usually just enough space is provided between bipolar plates in the thickness direction of the stack that, on the one hand, there is sufficient space in the active region to accommodate the relevant section of the MEA and, on the other hand, there is just enough space for defined compression of this section of the MEA. As a result, more space is sometimes reserved in the distribution and collection region than would in fact be necessary for the latter to function. If an MEA has an above-average thickness in the active region, this results in a lot of installation space in the distribution or collection region; if the MEA has a below-average, thin active region, this results in little installation space in the distribution or collection region. In the case of conventional plates, therefore, the bipolar plates are designed in such a way that the separator plates thereof partially come to bear against each other both in the active region and in the distribution or collection region and are at least partially welded to each other in these regions. However, pressure fluctuations in the coolant passed between the bipolar plates of a stack cause the separator plates to move relative to each other and expose the joints between the separator plates of a bipolar plate, for example welded joints in the distribution or collection region; for instance, if the spacing between mutually closest bipolar plates may be large in the region of the distribution or collection region, dynamic pressure fluctuations and loads occur which may lead to breakage of the welded joint and possibly even to perforation of one of the separator plates at the damaged joint.

An object of the present disclosure is therefore to provide a bipolar plate and assemblies containing the latter, in which thickness fluctuations of the membrane electrode assembly, for example of at least one of the gas diffusion layers thereof, have no destructive effect, or only a minor destructive effect, on the bipolar plate, such as during dynamic operation.

This object and others are achieved by embodiments of bipolar plates and systems comprising bipolar plates described herein.

The bipolar plate according to the present disclosure is suitable, inter alia, for an electrochemical system, such as for an electrolyzer, a fuel cell, an electrochemical compressor, or a redox flow battery.

It comprises at least a first and a second separator plate, which are arranged adjacent to each other in a direction perpendicular to the plate plane of the first and/or the second separator plate. In a plan view of this assembly of the two separator plates, each of the separator plates has at least two through-openings for passing a respective reaction medium through the separator plate. Typically, however, the separator plates have up to six such through-openings, via which two different reaction media and optionally a cooling fluid can be supplied and these two reaction media and/or the reaction products thereof and also the cooling fluid can also be discharged again; sometimes even more than two through-openings are provided for a medium. The following description refers to the aforementioned at least two through-openings for two different reaction media, for example for supplying the latter. However, one, some or all of the additional through-openings in the separator plates for discharging the reaction media or for supplying or discharging other media, and regions adjacent thereto, such as distribution regions or collection regions, may be designed in the same way.

Furthermore, the separator plates have an active region with structures for guiding a reaction medium along the surface of the separator plate that is located on the outer side of the bipolar plate. Different reaction media are guided through the active region on the outer side of each of the two separator plates, wherein in each case one of the two through-openings in the separator plates is used to supply or discharge one of the reaction media to or from the outer side of one of the separator plates.

For each of the separator plates, therefore, the reaction medium is guided on the outer side of the bipolar plate according to the present disclosure. In other words, on the two outer sides of the bipolar plate, flow channels are formed in each of the separator plates, for example by embossing, in each of which flow channels a reaction medium from one of the through-openings can be guided. The electrochemical reaction intended to take place in the electrochemical system between the reaction media separated by the MEA takes place in this active region; more precisely, protons pass through the MEA and thus enable the electrochemical reaction.

Furthermore, each of the separator plates has a distribution or collection region with structures for guiding the reaction medium from one of the aforementioned through-openings to the active region or from the active region to the through-opening. By way of example, as structures for guiding the reaction medium in the distribution or collection region, flow channels arranged on the outer side of the bipolar plate are provided for the reaction medium. If the bipolar plate or the separator plates thereof have additional through-openings with adjacent distribution regions or collection regions, these distribution regions or collection regions may also be designed in the same way as the distribution region described below. While the through-openings are arranged next to each other in a plan view of a bipolar plate, the distribution regions or collection regions at least partially overlap and extend in different planes. Bipolar plates usually have two areas in which distribution or collection regions overlap; in the case of fuel cells, usually three media systems are separated from each other in the distribution or collection regions, but are routed spatially one above the other in the stacking direction.

The present disclosure will be described below on the basis of a distribution region which is fluidically connected to one of the through-openings. However, whenever a distribution region is mentioned below, this could also be a collection region instead of a distribution region.

The channels in the distribution region are designed as grooves which are formed in the respective separator plate, for example by embossing, said grooves being separated from each other by corresponding webs which project towards the outside of the bipolar plate. The channels in the distribution or collection region of the separator plate of a bipolar plate may extend parallel to each other, at an angle to each other, in a manner curved by different radii to each other, or in a manner arranged completely randomly in relation to each other. The same applies when considering individually the other separator plate of the bipolar plate. For instance, the channels of the distribution region of the separator plate under consideration may extend as a set in parallel with each other over large areas of the distribution region; however, when the structures of a distribution region are projected into a common plane with an adjacent distribution region containing the set, channels of the adjacent distribution or collection region of the other separator plate of the bipolar plate may extend thereacross, for example at a positive angle.

The problem that arises when the installation space available between the reinforcing edges of different cells in the area of a distribution or collection region differs greatly in the thickness direction in order to compensate for any fluctuations in the MEA thickness in the active region, as described above, is now solved by the present disclosure in that the distribution or collection regions of at least one of the two separator plates, possibly even of each of the two separator plates, has/have at least one compensating region in which flow channels may be formed in a way. If compensating regions are provided in both separator plates, these compensating regions need not be arranged congruently in a plan view looking toward the plane of the bipolar plate. However, these compensating regions may at least partially overlap. For instance, a pairwise arrangement of partially or completely overlapping compensating regions of adjacent separator plates is advantageous. In principle, however, it is also possible to form the entire compensating region in just one separator plate.

According to the present disclosure, the flow channels in the compensating regions are designed in such a way that, in the non-compressed state, the rear sides of the channel bottoms of the flow channels of the separator plate are spaced apart from the rear sides of the channel bottoms of the flow channels of the adjacent separator plate. Here, the rear side is in principle considered to be that surface or place on a separator plate that does not face outwards in the bipolar plate, but rather is located in the interior of the bipolar plate. Usually, oxidizing agents and reducing agents and reaction products thereof are guided on the outward-facing surfaces of a bipolar plate, while cooling medium is guided in the interior, e.g. on the rear side of the separator plates. Given a substantially constant material thickness, a smallest possible spacing from the adjacent separator plate of the bipolar plate on the rear side is formed by those regions which, on the outer side, form the deepest regions of the respective channels or channel bottoms.

Since, in the region of the channel bottoms of the flow channels, the separator plates do not bear directly against each other in the compensating regions in the unassembled state, this results in a spacing between the two separator plates in the overlapping areas in the compensating region, by virtue of which it is possible to compensate for thickness fluctuations in a membrane electrode assembly.

This applies both in overlapping and in non-overlapping sections of the compensating regions, since in both cases the two separator plates are spaced apart from each other there in the unassembled state.

In the present disclosure, the expression “in the unassembled state” refers to the fact that the bipolar plate has not yet been compressed for final assembly of an electrochemical system. This means that a single bipolar plate may be in the unassembled state. However, this also applies to the bipolar plates in a stack of bipolar plates arranged one above the other, provided that the stack has not yet been compressed.

The channel bottoms may be straight or curved in cross-section, for example curved in a convex or concave manner.

Formed between the separator plates of a bipolar plate, outside of the compensating regions, is a contact plane at which the separator plates bear directly against each other with their rear sides/inner sides. This may take place in the area of sealing beads, which are intended to seal between the separator plates in a fluid-tight manner where necessary. The contact plane is formed in the region of the bead feet, e.g. directly adjacent to the sealing bead. Such sealing beads may be, for example, sealing beads around the through-openings, or a bead extending around the entire bipolar plate at its outer edge, a so-called perimeter bead. Adjacent to edge flanks of the distribution region, the separator plates may likewise come to bear partially against each other and form a contact plane.

At least in the non-compressed state, e.g., in the so-called “unassembled” state, the bipolar plate according to the present disclosure creates a free gap between the channel bottoms of adjacent separator plates in the at least one compensating region, which gap serves for tolerance compensation of thickness fluctuations of a membrane electrode assembly. For instance, this prevents the adjacent separator plates from being in the main line of force in the compensating regions when compressing a stack of bipolar plates. For example under dynamic loads, as occur for example and, for instance, when a coolant is introduced between the separator plates of a bipolar plate during operation, the risk of destruction of the bipolar plate is thereby reduced, while the latter is still inexpensive to manufacture and of simple design. According to the present disclosure, the compensating region in a separator plate may extend over the entire distribution region or else only over part of the distribution region, both transversely to the direction of extension of the flow channels in the distribution region and along the extension of the flow channels in the distribution region.

If the compensating region extends over only part of the distribution region, such as only over a section of the distribution region transversely to the direction of extension of the flow channels, one or more channels of the distribution region that are not part of the compensating region may not be set back from the contact plane, e.g. the rear side of the channel bottoms thereof may not be spaced apart from the contact plane, so that the rear sides of their channel bottoms bear against each other and rest against each other in the contact plane. The webs delimiting one or more of these channels may also have a deeper embossing on the gas side of the distribution region than the embossing of the channels in the compensating region. For instance, the web delimiting this or these channels towards the compensating region may have a deeper embossing. This design of the channels and webs in the distribution region adjacent to the compensating region enables the compensating region to act as a bending beam with a lateral through these channels and webs adjacent to the compensating region, and to create an elastic support effect to prevent the distribution region from collapsing at excessive gas pressures.

As an alternative or in addition, the compensating region may for example extend over a length L, where L≥50% of the length of a flow channel or advantageously L≥75% of the length of a flow channel. The compensating region may in this case extend from the area around a through-opening, such as from a sealing structure surrounding the through-opening, for example a weld seam or a sealing bead or an elastomer bead, into the distribution or collection region.

If, in the flow direction, the compensating region starts directly at one of the edges of the distribution region, the flow channels in the compensating region may be designed to be less deep than the outermost flank of one or both of the two outermost flow channels, the outermost flank or the outermost flow channel being considered in such a way that “outermost” is considered in the direction perpendicular to the direction of extension of the flow channels in the distribution region, possibly the direction of extension of at least one flow channel if the flow channels are not parallel. In other words, in this case, the transition from the channel bottom rear side plane to the contact plane between the adjacent separator plates takes place in the edge area of the flow region. Advantageously, the depth of the flow channels in the compensating region may be less deep, by 30 to 150 μm, than the height of the outer flank of one or both of the two outermost webs of the distribution region and/or than the height of a sealing structure surrounding the through-opening. Since the outermost web or the sealing structure defines the contact plane, the result is that, according to the present disclosure, the rear sides of the bottoms of the flow channels do not bear against each other in the compensating regions of the two separator plates in the non-compressed state. What is not meant here, however, is the transition regions in which the channels and/or webs extend out of the plate plane at the start or end of the flow channels—as viewed in the flow direction—e.g. the plate material is shaped out of the plate plane in order to form the channels, and consequently the rear sides of the bottoms of the flow channels also do not bear against each other in these transition regions.

The sealing structures may together have a height HD* between the outward-facing surfaces of the separator plates of the bipolar plates, where HD*≤1200 μm, in the individual separator plates such as 400μm≤HD≤600 μm in the unassembled state of the bipolar plate, and/or where HD*≤1140 μm, for example 330 μm≤HD≤570 μm, in the state compressed under the final assembly pressure. The first-mentioned number HD* (1200 μm or 1140 μm) may relate to the sealing elements of a bipolar plate; the next-mentioned numerical ranges HD may relate to the sealing elements in separator plates, e.g. such as single-layer plates.

The present disclosure additionally relates to an assembly of bipolar plates, comprising at least two bipolar plates, wherein the two bipolar plates are arranged adjacent to each other in a direction perpendicular to the plate plane, with the interposition of a reinforcing edge of a membrane electrode assembly. This perspective enables the MEA to be considered as the center of a unit within a fuel cell stack, whereas the previous perspective considers the bipolar plate as the center of a unit. When considering the MEA as the center of a unit, the bipolar plates adjacent thereto may be designed in such a way that they each have a sealing structure surrounding the through-opening, said sealing structures being arranged adjacent to each other in a direction perpendicular to the plate plane and sealing between the two bipolar plates. Here, the two sealing structures of the mutually facing separator plates of the first and second bipolar plate together have a total height HG, where 800 μm≤HG≤1200 μm in the unassembled state of the separator plate, and/or where 660 μm≤HG≤1140 μm in the state compressed under the final assembly pressure. This height is given as the height spanned between the sealing structures, minus the thickness of the MEA.

To seal between adjacent bipolar plates, sealing structures may also be provided on the outer surfaces of the separator plates, for example elastomer seals or beads integrally formed in the separator plate. In the assembled state, these then provide sealing between adjacent bipolar plates in a fluid-tight manner, such as towards the reinforcing edge of the MEA, for example circumferentially around through-openings in an intrinsically closed fashion.

A bipolar plate assembly according to the present disclosure comprises at least two of the above-described bipolar plates according to the present disclosure, which are arranged adjacent to each other, wherein located between these is a membrane-electrode assembly, the reinforcing edge of which is gripped by the two bipolar plates.

When a stack of alternately arranged bipolar plates and MEAs is compressed, the compensating regions formed in the separator plates of the bipolar plates can absorb and compensate for thickness fluctuations of the membrane electrode assembly.

Since adjacent separator plates of a bipolar plate do not come into contact with each other in the compensating regions in the unassembled state, e.g. the separator plates are not joined in a materially bonded manner in the compensating regions, dynamic loads in the compensating regions also do not lead to destruction of the separator plates and thus of the bipolar plate.

Examples of bipolar plates according to the present disclosure and of bipolar plate assemblies according to the present disclosure will be given below. Here, identical and similar elements of the separator plates and bipolar plates and assemblies will be provided with identical or similar reference signs, and therefore the description thereof will not always be repeated. The following examples include the features according to the present disclosure together with one or more optional enhancements or developments according to the present disclosure. However, it is possible also to use individual elements of these improvements and developments independently of the other elements of the respective examples or also in combination with some of the other elements of the same example or of other examples and to further improve the present disclosure as a result.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an electrochemical system according to the present disclosure.

FIG. 2 shows part of an electrochemical system according to the prior art.

FIG. 3 shows, in four subfigures 3A, 3B, 3C and 3D, a plan view of an anode plate of a bipolar plate according to the present disclosure.

FIG. 4 shows a cross-section through part of an assembly of bipolar plates according to the prior art.

FIGS. 5 to 8 show cross-sections through parts of assemblies of bipolar plates according to the present disclosure.

FIGS. 9 and 10 show oblique views of parts of a bipolar plate according to the present disclosure.

### DETAILED DESCRIPTION

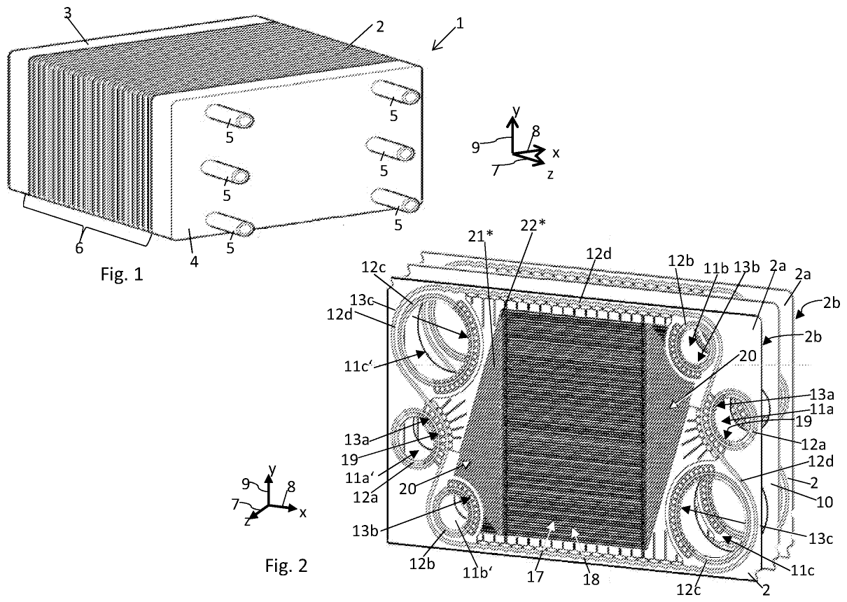

FIG. 1 shows an electrochemical system 1 comprising a plurality of structurally identical bipolar plates 2. The bipolar plates 2 are arranged as an assembly in a stack 6 and are stacked along a z-direction 7. The bipolar plates 2 of the stack 6 are clamped between two end plates 3, 4. The z-direction 7 will also be referred to as the stacking direction. In this example, the system 1 is a fuel cell stack. Each two adjacent bipolar plates 2 of the stack thus bound an electrochemical cell, which serves for example to convert chemical energy into electrical energy. To form the electrochemical cells of the system 1, a membrane electrode assembly (MEA) is arranged in each case between adjacent bipolar plates 2 of the stack (see, for example, FIG. 2). Each MEA typically contains a membrane, for example an electrolyte membrane. Furthermore, a gas diffusion layer (GDL) may be arranged on one or both surfaces of the MEA.

Alternatively, the system 1 shown in FIGS. 1 and 2 may also be in the form of an electrolyzer, an electrochemical compressor, or a redox flow battery. Bipolar plates can likewise be used in these electrochemical systems. The structure of these bipolar plates may then correspond to the structure of the bipolar plates 2 explained in detail here, although the media guided on and/or through the bipolar plates in the case of an electrolyzer, an electrochemical compressor, or a redox flow battery may differ in each case from the media used for a fuel cell system.

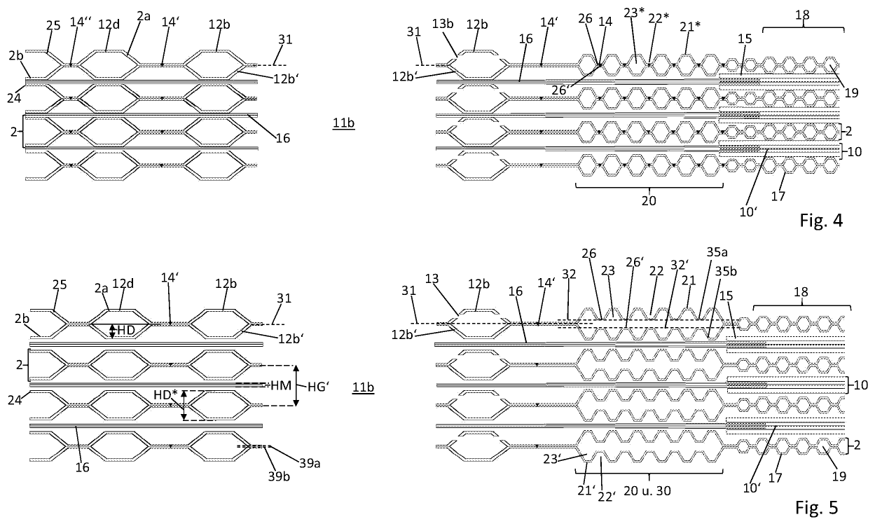

The z-axis 7, together with an x-axis 8 and a y-axis 9, spans a right-handed Cartesian coordinate system. The bipolar plates 2 each define a plate plane E (cf. FIG. 4), in which the metal layers (separator plates) forming the bipolar plates come into contact with each other. In their unshaped regions, the separator plates also form their own plate plane, wherein the plate planes of both the bipolar plates and the separator plates are in each case oriented parallel to the x-y plane and thus perpendicular to the stacking direction or to the z-axis 7. The end plate 4 has a plurality of media ports 5, via which media can be supplied to the system 1 and via which media can be discharged from the system 1. Said media that can be supplied to the system 1 and discharged from the system 1 may comprise for example fuels such as molecular hydrogen or methanol, reaction gases such as air or oxygen, reaction products such as water vapor or depleted fuels, or, if necessary, coolants such as water and/or glycol. In the case of an electrolyzer, water is supplied to the stack and oxygen and hydrogen are discharged therefrom.

FIG. 2 shows, in a perspective view, two adjacent bipolar plates 2, known from the prior art, of an electrochemical system of the same type as the system 1 from FIG. 1, as well as a membrane electrode assembly (MEA) 10 which is arranged between these adjacent bipolar plates 2 and is likewise known from the prior art, the MEA 10 in FIG. 2 being largely obscured by the bipolar plate 2 facing towards the viewer. The bipolar plate 2 is formed of two separator plates 2a, 2b (hereinafter also referred to as separator plates) which are joined together in a materially bonded manner, of which only the first separator plate 2a facing towards the viewer is visible in FIG. 2, said first separator plate obscuring the second separator plate 2b. The separator plates 2a, 2b may each be manufactured from a metal sheet, for example from a stainless-steel sheet or a sheet made of a titanium alloy. The sheets may be partially or fully coated or plated, for example by means of a corrosion-inhibiting and/or conductivity-increasing coating. The separator plates 2a, 2b may for example be joined to each other in a materially bonded manner, for example by welding, soldering or adhesive bonding, such as by laser-welded joints. The MEA 10 has, along its outer edge, a reinforcing edge at which the MEA is clamped between the two bipolar plates 2 in a fluid-tight manner.

The separator plates 2a, 2b have through-openings, which are aligned with each other and form through-openings 11a-c of the bipolar plate 2. When a plurality of bipolar plates of the same type as the bipolar plate 2 are stacked, the through-openings 11a-c together with aligned through-openings in the reinforcing edges of the MEAs form lines which extend through the stack 6 in the stacking direction 7 (see FIG. 1). Typically, each of the lines formed by the through-openings 11a-c is fluidically connected to one of the ports 5 in the end plate 4 of the system 1. For example, coolant can be introduced into the stack or discharged from the stack via the lines formed by the through-openings 11a. In contrast, the lines formed by the through-openings 11b, 11c may be configured to supply fuel and reaction gas to the electrochemical cells of the fuel cell stack 6 of the system 1 and to conduct the reaction products out of the stack. The media-guiding through-openings 11a-c are each substantially parallel to the plate plane.

In order to seal off the through-openings 11a-c with respect to the interior of the stack 6 and with respect to the surrounding environment, the first separator plates 2a may each have sealing arrangements in the form of sealing beads 12a-c, which are arranged in each case around the through-openings 11a-c and in each case completely surround the through-openings 11a-c. On the rear side of the bipolar plates 2, facing away from the viewer of FIG. 2, the second separator plates 2b have corresponding sealing beads for sealing off the through-openings 11a-c (not shown).

In an electrochemically active region 18, the first separator plates 2a have, on the front side thereof facing towards the viewer of FIG. 2, a flow field 17 with structures (channels and webs) for guiding a reaction medium along the front side of the separator plate 2a. In FIG. 2, these structures are defined by a plurality of webs and by channels extending between the webs and delimited by the webs. On the front side of the bipolar plates 2, facing towards the viewer of FIG. 2, the first separator plates 2a additionally each have a distribution or collection region 20. The distribution or collection region 20 comprises structures which are designed to distribute over the active region 18 a medium that is introduced from a first of the two through-openings 11b into the distribution or collection region 20 and/or to collect or to pool a medium flowing towards the second of the through-openings 11b from the active region 18. In FIG. 2, the respectively corresponding through-openings that serve to supply or discharge the same fluid, the latter possibly being modified in the course of the electrochemical reaction, are designated with and without an apostrophe, e.g. 11a and 11a′. In FIG. 2, the distributing structures of the distribution or collection region 20 are likewise defined by webs 21* and by channels 21* extending between the webs 21* and delimited by the webs 21*. In general, the elements 17, 18, 20 can therefore be interpreted as media-guiding embossed structures.

In such a conventional bipolar plate, the two separator plates 2a and 2b bear directly against each other and support each other in the region of the bottoms of the channels in the distribution regions 20. The two separator plates 2a and 2b are usually joined to each other at contact points in the distribution regions 20, such as by welding.

The sealing beads 12a-12c have passages 13a-13c which serve to pass media through the sealing beads. By way of example, the passages 13a enable coolant to pass between the through-opening 12a and the distribution region 20, so that the coolant enters the distribution region between the separator plates and is guided out therefrom. Furthermore, the passages 13b enable hydrogen to pass between the through-opening 12b and the distribution region on the upper side of the upper separator plate 2a. The passages 13c enable air, for example, to pass between the through-opening 12c and the distribution region 20, so that air enters the distribution region 20 on the underside of the lower separator plate 2b and is guided out from this distribution region 20. The through-openings 11a or the lines through the plate stack of the system 1 that are formed by the through-openings 11a are in each case fluidically connected to each other via a cavity 19 which is enclosed by the separator plates 2a, 2b. If necessary, this cavity 19 can serve to guide a coolant through the bipolar plate 2, for example in order to cool the electrochemically active region 18 of the bipolar plate 2.

The first separator plates 2a each also have a further sealing arrangement in the form of a perimeter bead 12d, which extends around the flow field 17 of the active region 18 and also around the distribution or collection region 20 and the through-openings 11b, 11c and seals these off with respect to the through-opening 11a, that is to say with respect to the coolant circuit, and with respect to the environment surrounding the system 1. The second separator plates 2b each comprise corresponding perimeter beads 12d. In alternative plate designs, the perimeter bead may also enclose the coolant openings and thus the entire coolant circuit. The structures of the active region 18, the webs and channels of the distribution or collection region 20 and the sealing beads 12a-d are each formed in one piece with the separator plates 2a and are integrally formed in the separator plates 2a, for example in an embossing, deep-drawing or hydroforming process. The same applies to the corresponding distributing structures and sealing beads of the second separator plates 2b.

For instance in the case of a fuel cell, the separator plates 2a, 2b of the bipolar plate 2 may each be formed, for example, from a stainless steel sheet having a thickness of less than 100 μm. In the case of an electrolyzer, it is possible to use either sheets made of a titanium alloy or sheets made of fully coated stainless steel. The sheet thicknesses are usually greater in electrolyzers; for example, they can be 100-800 μm, 150-500 μm, for example 200-300 μm. The bipolar plate 2 usually has a substantially rectangular shape, but it may also be round or oval, such as in the case of electrolyzers.

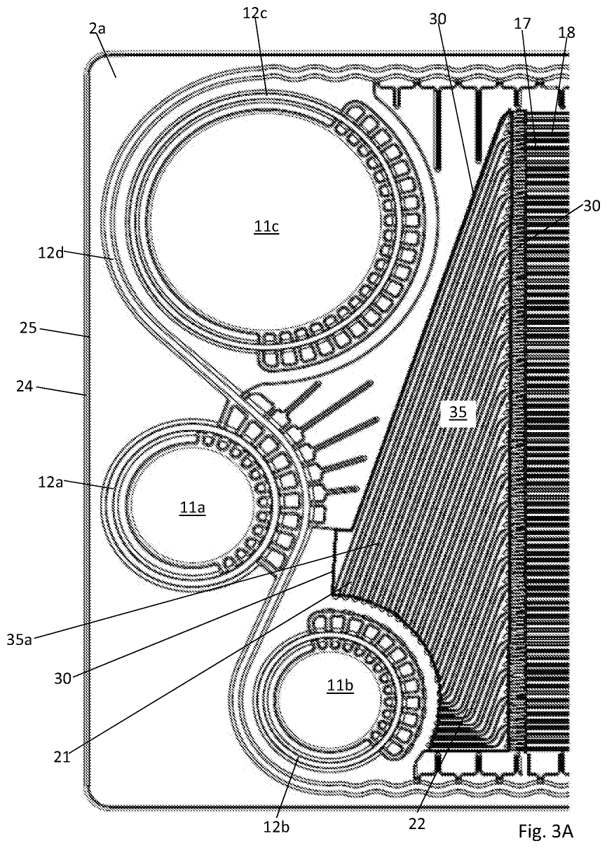

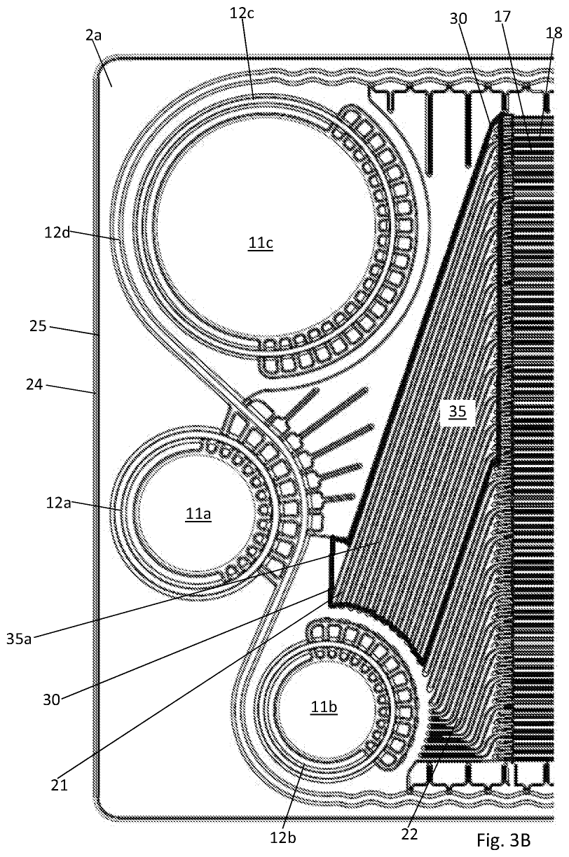

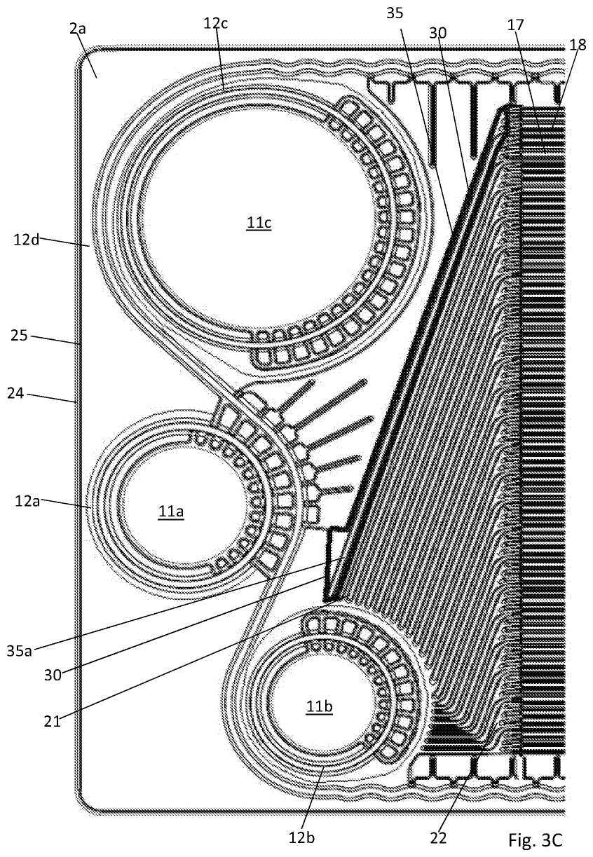

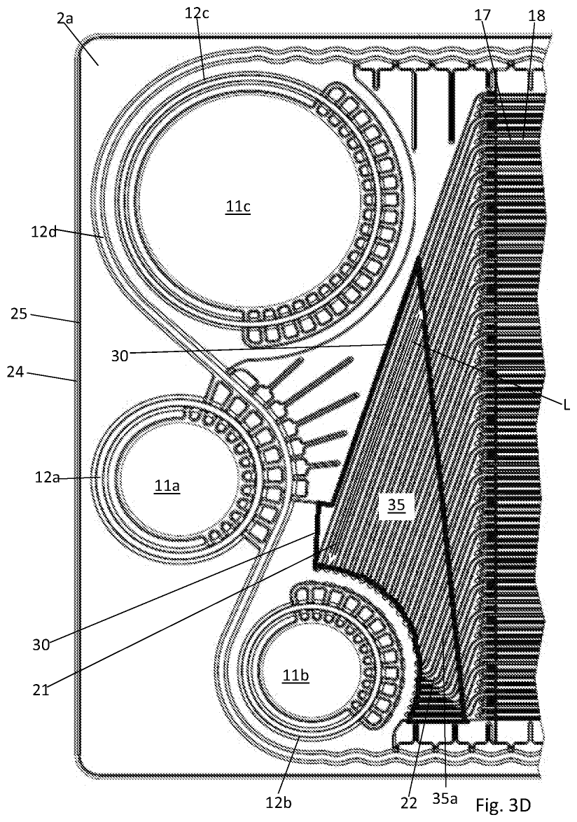

FIG. 3 shows, in sub-figures 3A, 3B, 3C and 3D, a partial view of three different bipolar plates 2 according to the present disclosure, all of which are designed similarly to that shown in FIG. 2. In a manner differing from the bipolar plate in FIG. 2, the distribution region 20, which guides the reaction medium to the active region 17, 18, is designed in such a way that the area bounded by the thick line is configured as a compensating region 35. In the sub-figures of FIG. 3, a reference sign 30 additionally points to the boundary line of the compensating region 35 in order to illustrate the extent thereof. In this compensating region, the fluid channels are embossed in such a way that the separator plate 2a, in the region of the bottoms of the fluid channels, does not extend as far as the plane of contact E, 31 with the separator plate 2b, which in this view is located behind the plane of the drawing, and therefore the separator plate 2a does not come into contact with the separator plate 2b in the compensating region. When compressing a stack of bipolar plates 2, the compensating region therefore serves for tolerance compensation for uneven thicknesses of the membrane electrode assembly (MEA) between the bipolar plates.

In the embodiment of FIG. 3A, the compensating region 35 extends over all the channels of the distribution region 20. In FIG. 3B, the compensating region extends over the entire length of a subset of channels of the distribution region 20, and in the embodiment of FIG. 3C the compensating region extends only over the entire length of that channel of the distribution region 20 which is arranged closest to the through-openings 11a and 11c, in other words only over the edge of the distribution region 20 adjacent to the through-openings 11a and 11c. It has been shown in practice that, for the durability of the bipolar plates, it may be effective if the compensating region is arranged in such a way that it is adjacent to the coolant through-opening 11a. FIG. 3C also shows, by way of example, a typical course of weld seams. The weld seams are not shown in the other sub-figures of FIG. 3, even though they are actually present. In the embodiment of FIG. 3D, the compensating region 35 extends over all the channels of the distribution region 20, but only over a length L corresponding to approximately 70% of the total length of the channels, e.g. on the end of the distribution region 20 facing towards the active region 18, the rear sides 26, 26′ of the bottoms of the gas channels 22 are not raised and the rear sides of the channel bottoms can at least partially come to bear against each other. Alternatively, instead of a continuous 70% length, it would also be possible to combine a section of at least 50% length with a section of smaller length spaced apart therefrom, wherein the elevation can be omitted in the intermediate region separating the sections.

FIG. 4 shows, in a partial plan view, a cross-section through four bipolar plates 2 arranged one above the other in the stacking direction 7 according to the prior art. A membrane electrode assembly 10 is arranged in each case between the bipolar plates 2. In the active region 18, the MEA 10 comprises three layers. Arranged in the middle is a proton-permeable membrane 10′. A gas diffusion layer 15 is arranged on each side of the membrane 10′. The electrodes, which are connected to the membrane, and the catalyst layer are not shown. Outside the active region 18, the MEA comprises a two-layer reinforcing edge 16, which in the case of fuel cells is usually made of a thin, polymer-based material and surrounds the active region 18. The part shown in FIG. 4 surrounds the through-opening 11b for a reaction gas, but to the left it extends as far as the outer edge 24 of the bipolar plate 2.

Using the uppermost bipolar plate 2 in the drawing as an example, the structure of the bipolar plate will now be explained. This is identical for the adjacent bipolar plates.

The bipolar plate 2 comprises two separator plates 2a and 2b, which are arranged adjacent to each other. These each have a sealing bead 12b and 12b′ surrounding the through-opening 11b, the sealing beads being designed as full beads and surrounding the through-opening 11b in an intrinsically closed manner. The two separator plates 2a and 2b are joined by means of a weld seam 14′ around at least part of the circumference surrounding the full beads 12b, 12b′. A welded joint 14″, which likewise joins the separator plates 2a and 2b, also extends between the perimeter bead 12d and the embossment 25 on the outer edge 24 of the bipolar plate 2.

Arranged between the sealing bead 12b and the active region 18 is the distribution region 20, in which webs 21 and channels 22 are formed by embossing. At the base of the channels 22, the adjacent separator plates 2a and 2b are welded to each other at weld spots 14. In the separator plate 2a shown at the top in FIG. 4, reaction gases are passed from the through-opening 11b, via passages 13b in the sealing bead 12b and the channels 22 in the distribution region 20, to the active region 18.

If coolant is not just introduced into the intermediate space 19 between the separator plates 2a and 2b, but rather is introduced at greatly fluctuating pressures depending on other operating parameters, then the separator plates, if not fixed to each other by means of welded joints 14 as in FIG. 4, tend to yield in the direction of the MEA or the reinforcing edge thereof, which can lead to curvatures and deformations in the separator plates, thereby having a negative effect on the durability of the separator plates. Furthermore, in the event of such deformations, it is no longer possible to ensure a reproducible supply of media and/or a homogeneous distribution of media over the width of the active region because the volumes of the flow spaces fluctuate and/or are permanently changed. Conventional designs attempt to counteract this by means of weld seams 14 in the distribution region. If strongly fluctuating pressures are then applied to the welded joints 14 here, these welded joints 14 may be affected by the coolant pressure, which may possibly lead to these joints failing, in which case the welded joints are usually not simply detached, but rather the material of the separator plates may be torn.

Conventional designs also have the problem that, due to the distance between the MEA reinforcing edge 16 and the webs 21 of the distribution or collection region 20, the MEA reinforcing edge 16 does not have any defined support and therefore may flutter.

FIG. 5 shows a cross-section through part of a stack 1, which is designed in the same way as the stack in FIG. 4. In a manner differing from the stack 1 and the bipolar plates 2 of FIG. 4, the bipolar plates 2 are designed according to the present disclosure in the distribution region 20. Provided in the distribution region 20 is a compensating region 35a or 35b, in which the channels 22 have a smaller depth, so that the separator plates 2a and 2b do not come into contact with each other at the rear sides 26, 26′ of the bottoms of the channels 22. The planes 32, 32′ of the rear sides of the channel bottoms 22 are shifted in the direction of the respective plate with respect to the contact plane E, 31 of the separator plates 2a, 2b. When the stack 1 shown in the non-compressed state in FIG. 5 is compressed, thickness fluctuations between the MEAs 10 and dynamic fluctuations of the separator plates 2a and 2b can be absorbed since, in the compensating region 35, the separator plates 2a and 2b can yield to the pressure acting perpendicular to the layer plane and can deform. This avoids or at least reduces damage to the separator plates 2a and 2b and thus to the bipolar plate 2. Also shown in FIG. 5 are the plate planes 39a, 39b of the separator plates 2a, 2b, which extend in the neutral axis of the plate material in the non-deformed regions thereof.

FIG. 5 also shows the height HD of a sealing bead 12a in a separator plate 2a, as well as the height HD* of both sealing beads 12a, 12′ of the bipolar plate 2. Also illustrated in FIG. 5 are the height ratios when considering an assembly of at least two bipolar plates 2 with an MEA 10 arranged between the bipolar plates 2. The height HG of the sealing elements, here the beads 12b, 12b′, is given as the spacing HG′ between the contact planes 31 of the mutually closest bipolar plates, minus the height HM of the MEA 10.

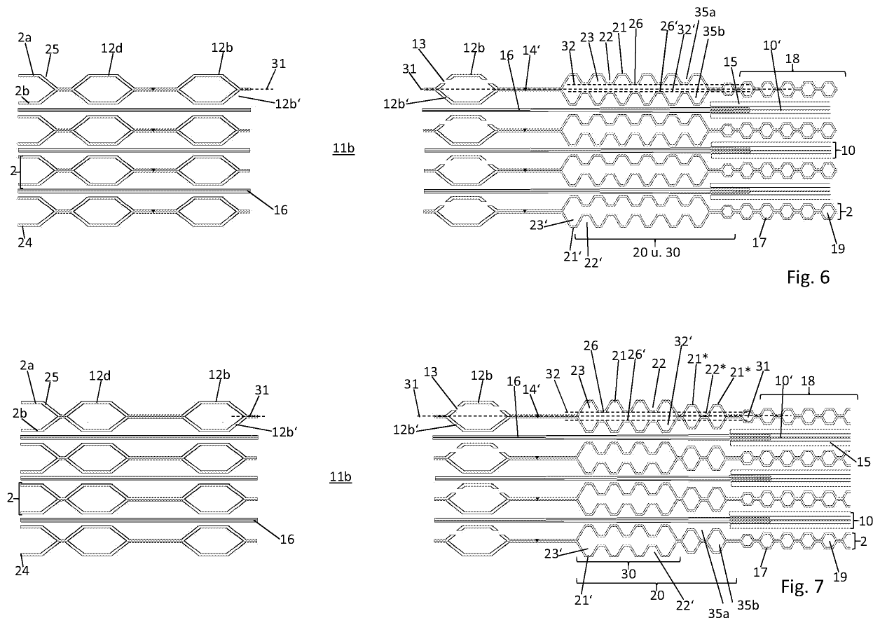

FIG. 6 shows a stack 1 as in FIG. 5. In a manner differing from FIG. 5, the channels 22 in the compensating region 35a in the separator plate 2a are less deep than the channels 22′ in the compensating region 35b of the separator plate 2b. The plane 32 of the rear sides of the channel bottoms 22 of the first separator plate 2a is shifted further away from the contact plane E, 31 of the separator plates 2a, 2b than the plane 32′ of the rear sides of the channel bottoms 22′ of the second separator plate 2b. However, the total height from the channel depths of adjacent channels 22 and 22′ is the same as that in FIG. 5.

The embodiment of FIG. 7 shows a stack 1 as in FIG. 5. In a manner differing from FIG. 5, the compensating regions 35a and 35b extend only over part of the width of the distribution region 20. Here, the rear sides 26, 26′ of the channel bottoms of the two separator plates 2a, 2b are spaced apart from each other. In contrast, the two channels located furthest to the right in the compensating regions 35a and 35b in FIG. 7, including the channel 22*, are not themselves set back from the contact plane 31 and are not arranged with their channel rear sides at a distance from the contact plane 31; the webs 21* delimiting the channel 22* are also embossed deeper on the gas side of the distribution region. In the illustrated cross-section of FIG. 7, these webs 21* enable the compensating regions 35a and 35b to act as a bending beam, the support of which is formed, inter alia, by the webs 21*. The webs 21* provide an elastic support effect to prevent the compensating region and thus the distribution region from collapsing at excessive gas pressures.

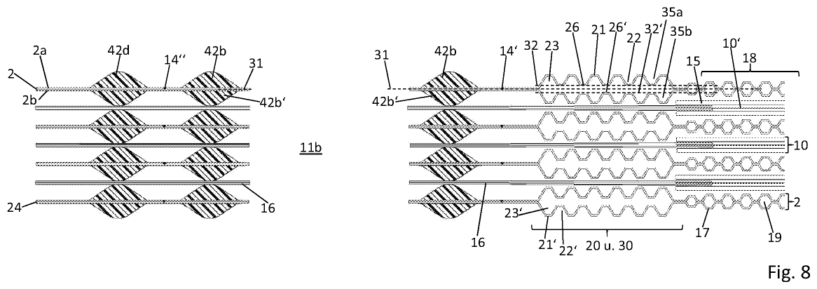

FIG. 8 shows a stack 1 as in FIG. 5. In a manner differing from FIG. 5, elastomer beads 42b, 42b′ are now applied as sealing elements to the outer sides of the separator plates 2a, 2b. An embossment adjacent to the outer edge 24 is omitted here. Other than this, the distribution region 20 is designed in the same way as in FIG. 5.

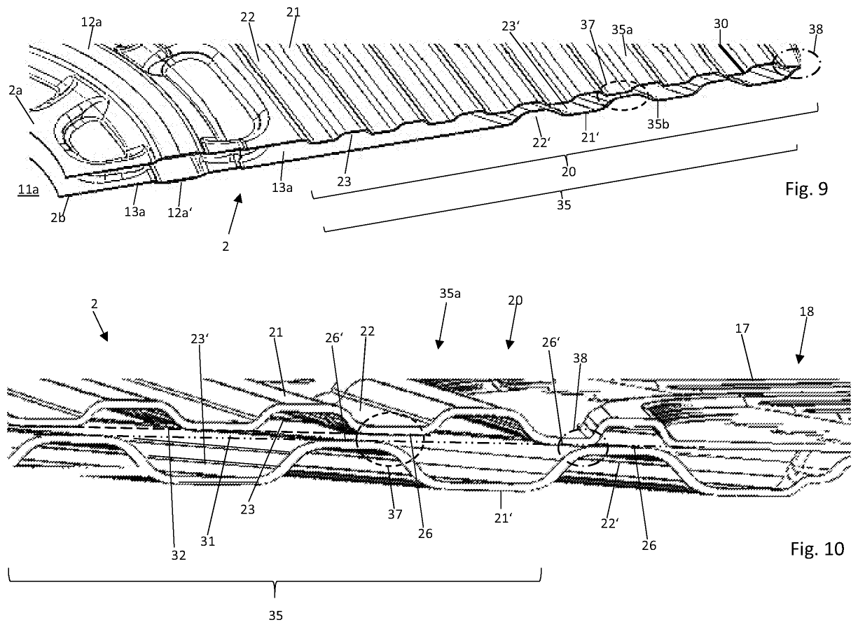

FIGS. 9 and 10 show cut-open oblique views of a real bipolar plate 2 according to the present disclosure. The first cut extends from a through-opening 11a, through a bead 12a, and further through a distribution region 20. It ends before the end of the distribution region 20, but beyond the compensating region 35. Adjacent to the bead 12a, the cut extends through a passage 13a through the sealing bead 12a for guiding cooling medium through the sealing bead 12a. In a manner differing from FIGS. 2 and 3, the perimeter bead here extends adjacent to the outer edge of the bipolar plate and is thus not cut in FIG. 9 and is therefore also not shown. It is clear from FIG. 9 that the coolant channels 23′ in the lower separator plate 2b have a different direction of extension than the coolant channels 23 in the upper separator plate 23 and partially cross over the latter. In FIG. 9, one such crossing region 37 is shown in the compensating region 35 and is encircled by a dashed line. Here, the channel bottom rear sides of the gas channels 22, 22′ are spaced apart from each other, while at the right-hand edge, e.g. outside the compensating region 35 or to the right of the boundary line 30, the channel bottom rear sides of the gas channels 22, 22′ come into contact with each other, as can be seen in the region 38 encircled by the dash-dotted line.

FIG. 10 shows a cut-open view of the same bipolar plate 2, but now in a part which starts in the compensating region 35 and extends as far as the active region 18. Once again, the channels 22 of the separator plate 2a are arranged in such a way that they overlap the channels 22′ of the separator plate 2b and cross over the course thereof. In the compensating region 35, the plane 32 of the rear surface of the separator plate 2a in the region of the bottoms of the channels 22 is spaced apart from the contact plane 31 between the two separator plates 2a and 2b, whereas in the part of the distribution region 20 that does not belong to the compensating region 35 the channel bottom rear side plane 32 of the channels 22 and 22′ of the separator plates 2a and 2b coincides with the contact plane 31. Also in this case, there is in the compensating region a tolerance gap between the two separator plates 2a and 2b, which serves to compensate for thickness fluctuations of an MEA and allows dynamic pressure fluctuations in the coolant channels 23 and 23′, but also in the gas channels 22 and 22′, without any significant risk of destruction.

FIGS. 1-10 are shown approximately to scale. FIGS. 1-10 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” or “substantially” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A bipolar plate for an electrochemical system, comprising a first separator plate and a second separator plate, which are arranged adjacent to each other in a direction perpendicular to the plate plane of the first and/or the second separator plate, wherein the first and the second separator plate each comprising:
at least two through-openings, which are adjacent to each other in the layer plane, for passing a reaction medium through the separator plate;
an active region with structures for guiding a reaction medium along a flat side of the separator plate; and
a distribution or collection region with structures for guiding a reaction medium between one of the through-openings and the active region, wherein the structures for guiding the reaction medium in the distribution or collection region comprise flow channels for the respective reaction medium, said flow channels being separated from each other by webs, and
wherein, the at least two through-openings are adjacent to each other in a direction perpendicular to the plate plane,
wherein, adjacent to the first through-opening, the separator plates bear directly against each other in a contact plane,
wherein, the distribution or collection region of the first separator plate and/or the distribution or collection region of the second separator plate have at least one compensating region, and
wherein, in the unassembled state of the bipolar plate, the rear side of the channel bottoms of the flow channels that faces towards the respectively adjacent separator plate is arranged spaced apart from the contact plane in the at least one compensating region, as viewed from the adjacent separator plate.

2. The bipolar plate according to claim 1, wherein compensating regions are arranged in both separator plates, said compensating regions being arranged in a pairwise fashion in mutually adjacent separator plates and being adjacent each other perpendicular to the plate plane and being arranged in an at least partially overlapping manner.

3. The bipolar plate according to claim 1, wherein, in one, some or all of the compensating regions, the rear sides of the channel bottoms that face towards the respectively adjacent separator plate are arranged at least partially at the respectively lowest regions of the channel bottoms in a channel bottom rear side plane, which in the unassembled state of the bipolar plate extends parallel to and spaced apart from the contact plane, as viewed from the adjacent separator plate.

4. The bipolar plate according to claim 1, wherein, for one, some or all of the compensating regions of the first and/or second separator plate, the compensating regions extend over one, some, some but not all, or all of the flow channels of the distribution or collection regions.

5. The bipolar plate according to claim 1, wherein for one, some or all of the compensating regions of the first and/or second separator plate, the compensating region for one, some, some but not all, or all of the flow channels extends over a length L, where L≥50% of the length of the respective flow channel.

6. The bipolar plate according to claim 1, wherein, for one, some or all of the compensating regions of the first and/or second separator plate, the transition from the contact plane to the channel bottom rear side plane takes place directly adjacent to a sealing structure which directly surrounds the through-opening, and/or directly adjacent to a weld seam which directly surrounds the through-opening and joins the two separator plates to each other.

7. The bipolar plate according to claim 1, wherein, for one, some or all of the compensating regions of the first and/or the second separator plate, the flow channels in the compensating region are less deep than the outer flank of one or both of the two outermost flow channels.

8. The bipolar plate according to claim 7, wherein, for one, some or all of the compensating regions of the first and/or the second separator plate, one, some, some but not all, or all of the flow channels in the compensating region are at least partially less deep than the height of the outer flank of one or both of the two outermost webs of the distribution or collection region and/or than the height of a sealing structure surrounding the through-opening.

9. The bipolar plate according to claim 1, wherein the first and/or second separator plate has a sealing structure surrounding the through-opening, wherein, in the case where both the first and the second separator plate have a sealing structure surrounding the through-opening, the two sealing structures are arranged adjacent to each other in a direction perpendicular to the plate plane.

10. The bipolar plate according to claim 9, wherein, for the first and/or second separator plate, the sealing structure of the respective separator plate has a height HD relative to the outward-facing surface of the separator plate in the regions adjacent to the sealing structure, where 400 μm≤HD≤600 μm in the unassembled state of the bipolar plate, and/or where 330 μm≤HD≤570 μm in the state compressed under the final assembly pressure, and/or, for the sealing structures of adjacent separator plates arranged on top of each other, has a height HD* relative to the outward-facing surface of the separator plate in the regions adjacent to the sealing structure, where HD*≤1200 μm in the unassembled state of the bipolar plate, and/or where HD*≤1140 μm in the state compressed under the final assembly pressure.

11. The bipolar plate according to claim 8, wherein, for the first and/or second separator plate, the sealing structure is formed by an elastomer seal which is arranged on the outer surface of the separator plate and/or by a bead which is integrally formed in the separator plate and projects beyond the outer surface of the separator plate.

12. An assembly of bipolar plates, comprising at least two bipolar plates according to claim 1,
wherein the two bipolar plates are arranged adjacent to each other in a direction perpendicular to the plate plane, with the interposition of a reinforcing edge of a membrane electrode assembly.

13. The assembly according to claim 12, wherein the two bipolar plates have a sealing structure surrounding the through-opening, said sealing structures being arranged adjacent to each other in a direction perpendicular to the plate plane and sealing between the two bipolar plates, wherein the two sealing structures of the mutually facing separator plates of the first and second bipolar plate together have a total height HG, where 800 μm≤HG≤1200 μm in the unassembled state of the separator plate, and/or where 660 μmi≤HG≤1140 μm in the state compressed under the final assembly pressure.
